(19) United States
(12) Patent Application Publication
(10) Pub. No.: US 2024/0208656 A1
(43) Pub. Date: Jun. 27, 2024

(54) MONOLITHIC FABRIC OR FLEXIBLE MATERIAL FOR INFLATABLE SAFETY PRODUCTS

(71) Applicant: Air Cruisers Company, LLC, Wall Township, NJ (US)

(72) Inventors: Thomas W. Swierkocki, Manasquan, NJ (US); Christian Thomson, Wall Township, NJ (US); Michael Montenegro, Brick, NJ (US)

(21) Appl. No.: 18/086,979

(22) Filed: Dec. 22, 2022

(51) Int. Cl. B64D 25/00; D06M 11/83

(52) U.S. Cl. CPC B64D 25/00; D06M 11/83; D06M 2101/20

(57) ABSTRACT

A fabric or flexible composite material for an inflatable safety product includes a substrate with a plurality of gaps and voids. The fabric or flexible composite material also includes a material filling and/or sealing the gaps and voids of the substrate. The material filling and/or sealing the gaps and voids of the substrate may prevent air gas from travelling through the substrate along a substrate plane of the substrate.

### FIELD OF THE INVENTION

The field of the invention relates to air-holding and component or accessory fabrics or flexible composite materials, and, more particularly, to fabrics or flexible composite materials for an inflatable safety product.

### BACKGROUND

Federal aviation safety regulations require aircraft to provide evacuation and other safety provisions for passengers. These include evacuation slides, evacuation slide/rafts, ramps, slide/ramps, life rafts, life vests, helicopter floats and other life-saving inflatable devices. Relevant inflatable products that can be improved using the fabrics or flexible composite materials of the present disclosure can include evacuation slides, evacuation slides/rafts, evacuation ramps, evacuation slide/ramps, aviation life rafts, marine life rafts, emergency floats, emergency flotation systems, life preservers/vests, emergency flotation devices, inflatable shelters (military and nonmilitary), ship decoys and inflatable military targets, and any other flotation devices, rescue equipment, or other safety device requiring rapid inflation and/or secure air-holding functions or gas-holding functions. These inflatable devices are generally built from an assembly of inflatable tubular structures that form air beams that are sealed to one another. Inflatable escape slides and life rafts also have non-air-holding features, such as floors, sliding surfaces, girts, patches, handles, pouches, containers, structural attachments, accessories, components, and other features.

Typically, in order to form the tubular structures, many pieces of fabric or flexible composite material (which may be referred to herein as panels) are joined together. Safety regulations set strength requirements for the fabric or flexible composite material itself (the field of the inflatable tube), as well as strength requirements for the seam areas. In certain embodiments, the tubular structures may be substantially leak proof when inflated to keep the inflation gas inside the tubes for long durations.

In order to meet these and other existing coated fabric or flexible composite material performance requirements of tensile strength (i.e., a minimum of 190 lbs/in) and tear strength (i.e., a minimum of 13 lbs/in), current fabrics utilize generally heavy polyamide substrates having a minimum average weight of 4.5 ounces/yd² and a yarn tenacity of 6.5 to 8.8 grams/denier.

Conventional fabrics or flexible composite material for inflatable safety products utilize polyamide substrates that are coated with solvent-based polyurethane coatings on opposing surfaces of the substrate. The solvent-based polyurethane coating on the outside surface of the substrate provides abrasion resistance, heat resistance, and the means to adhere seam tapes, components, accessories, and/or other fabrics to the outside surface of the fabric. The solvent-based polyurethane coating on the inside surface of the substrate provides a gas barrier layer to the substrate to create an air-holding or gas-holding fabric. Conventional coatings on the inner and outer surfaces of the substrate do not penetrate the substrate, and air or gas is able to travel through the substrate along a same plane as the gas barrier layer. This phenomenon, known as wicking, allows air or gas to travel along the length of the fibers, filaments, threads, yarns, or tows of a substrate. A puncture, cut, breech, abrasion, or other failure of one or both coatings may compromise the gas-holding properties of the fabric or flexible composite material. Conventional fabrics with solvent-based polyurethane coatings are also generally heavy, thereby taking up weight on vehicles. Due to weight restrictions on aircraft, adding material to fill or seal gaps or voids, in the substrate, or space between the inner and outer coatings of a substrate has been avoided.

### SUMMARY

The terms “invention,” “the invention,” “this invention” and “the present invention” used in this patent are intended to refer broadly to all of the subject matter of this patent and the patent claims below. Statements containing these terms should be understood not to limit the subject matter described herein or to limit the meaning or scope of the patent claims below. Embodiments of the invention covered by this patent are defined by the claims below, not this summary. This summary is a high-level overview of various aspects of the invention and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings and each claim.

According to certain embodiments of the present invention, a fabric or flexible composite material for an inflatable safety product includes a substrate with a plurality of gaps and voids and material filling and/or sealing the gaps and voids of the substrate.

According to certain embodiments of the present invention, a fabric or flexible composite material for an inflatable safety product includes a substrate defining a substrate plane and material filling and/or sealing the gaps and voids of the substrate. The material filling and/or sealing the gaps and voids of the substrate may prevent gas from travelling through the fibers, filaments, threads, yarns, or tows or through the substrate along the substrate plane.

According to certain embodiments of the present invention, a fabric or flexible composite material for an inflatable safety product includes a substrate and a film covering a surface of the substrate, wherein the fabric or flexible composite material maintains air-holding or gas-holding properties when a film covering the substrate is punctured, cut, breeched, abraded, or damaged.

Various implementations described in the present disclosure can include additional systems, methods, features, and advantages, which can not necessarily be expressly disclosed herein but will be apparent to one of ordinary skill in the art upon examination of the following detailed description and accompanying drawings. It is intended that all such systems, methods, features, and advantages be included within the present disclosure and protected by the accompanying claims.

### BRIEF DESCRIPTION OF THE DRAWINGS

FIG. 1 is a cross-sectional view of a portion of a fabric or flexible composite material for an inflatable safety product according to certain embodiments of the present invention

FIG. 2 is a cross-sectional view of a portion of a substrate of the fabric or flexible composite material of FIG. 1.

FIG. 3 is another cross-sectional view of the substrate of the fabric or flexible composite material of FIG. 1.

### DETAILED DESCRIPTION

The subject matter of embodiments of the present invention is described here with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described.

Described herein are fabrics or flexible composite materials for inflatable safety products that include a substrate and at least one a material filling and/or sealing gaps and voids between the fibers, filaments, threads, yarns, or tows of a substrate or the space between a coating, film, or layer covering a surface of the substrate. The substrate of the fabric or flexible composite material may be a woven substrate or a nonwoven substrate. While the fabrics or flexible composite materials are discussed for use with inflatable safety products such as evacuation slides, evacuation slides/rafts, evacuation ramps, evacuation slide/ramps, aviation life rafts, marine life rafts, emergency floats, emergency flotation systems, life preservers/vests, emergency flotation devices, inflatable shelters (military and nonmilitary), ship decoys and inflatable military targets, and any other flotation devices, rescue equipment, or other safety devices, they are by no means so limited. Rather, embodiments of the fabrics or flexible composite materials may be used in fabric related applications of any type of inflatable safety product or otherwise as desired.

In various embodiments, the fabric or flexible composite materials described herein are utilized on inflatable safety equipment that is typically deflated, folded, and compressed to fit into confined areas on aircraft doors, within an aircraft fuselage, or in an aircraft storage compartment, thereby taking up space or volume on vehicles with volume restrictions such as aircraft.

In certain embodiments, the fabrics or flexible composite materials described herein may provide improved gas-holding or air-holding properties and durability by restricting air or gas flow through the substrate.

In various embodiments, the fabrics or flexible composite materials described herein may restrict air or gas from travelling through the substrate along a substrate plane and/or in a direction perpendicular to the substrate plane.

In various embodiments, the fabrics or flexible composite materials described herein may restrict air or gas from travelling through the substrate along a gas barrier plane and/or in a direction perpendicular to a gas barrier plane.

In various embodiments, the fabrics or flexible composite materials described herein may restrict air or gas from travelling through an outer surface of a fabric or flexible composite material.

In some embodiments, at least one film or coating is covering at least one surface of the substrate, and the fabric or flexible composite material may maintain gas-holding or air-holding properties when the at least one film or coating is punctured, cut, breeched, abraded, or otherwise damaged.

In various embodiments, the fabrics or flexible composite materials described herein may have smaller gaps and voids in the substrate compared to traditional fabrics or flexible composite materials. The fabrics or flexible composite materials described herein may be thinner compared to traditional fabrics or flexible composite materials and may have less space between inner and outer films on the substrates. In certain embodiments, the fabrics or flexible composite materials described herein may fill and/or seal the gaps and voids in the substrate without a weight penalty that traditional fabrics or flexible composite materials suffer from. In some embodiments, the fabrics or flexible composite materials described herein may fill and/or seal the gaps and voids in the substrate and achieve 13 lbs./in. tear strength due to increased strength of filaments.

Various other advantages and benefits may be realized with the systems and methods described herein, and the aforementioned benefits should not be considered limiting.

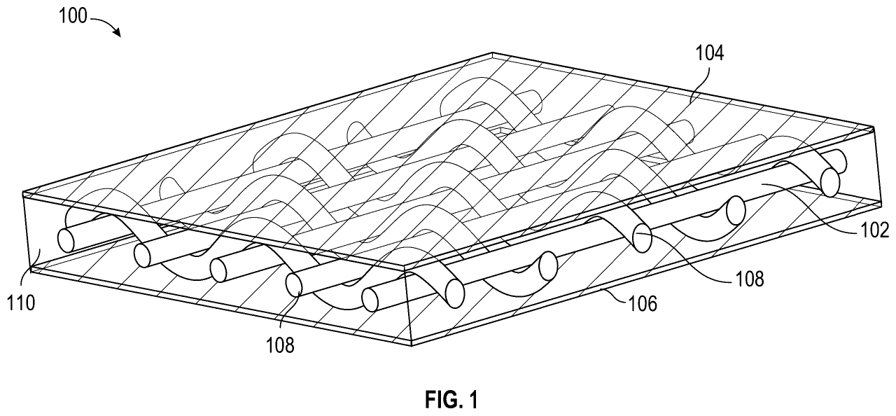

FIG. 1 illustrates an example of a portion of a fabric or flexible composite material 100 for an inflatable safety product according to embodiments. The fabric or flexible composite material 100 may be provided at various locations and/or form various portions of an inflatable safety product, optionally with different functionalities. As non-limiting examples, the fabric or flexible composite material 100 may be a gas-holding fabric or flexible composite material, a seam tape fabric or flexible composite material, a floor fabric or flexible composite material, a sliding surface fabric or flexible composite material, a girt fabric or flexible composite material, a patch fabric or flexible composite material, a handle fabric or flexible composite material, a pouch fabric or flexible composite material, a container fabric or flexible composite material, a structural attachment fabric or flexible composite material, an accessory fabric or flexible composite material, a component fabric or flexible composite material, or the like. Non-limiting examples of inflatable safety products with the fabric or flexible composite material 100 include, but are not limited to, an inflatable evacuation slide, inflatable evacuation slide/raft, inflatable evacuation ramp, inflatable evacuation slide/ramp, an inflatable life raft, an inflatable life vest, and/or an inflatable helicopter float, among others.

In certain embodiments, the fabric or flexible composite material 100 may have a weight of less than or approximately 8 ounces/yd². In some embodiments, the weight of the fabric or flexible composite material 100 is less than or approximately 6 ounces/yd², such as less than or approximately 5 ounces/yd². In some embodiments, the weight of the fabric or flexible composite material 100 is less than or approximately 4 ounces/yd². In some embodiments, the weight of the fabric or flexible composite material 100 is less than or approximately 3 ounces/yd². In some embodiments, the weight of the fabric or flexible composite material 100 is less than or approximately 2 ounces/yd². In some embodiments, the weight of the fabric or flexible composite material 100 is less than or approximately 1 ounce/yd². In some embodiments, the weight of the fabric or flexible composite material 100 is less than or approximately 0.5 ounces/yd².

The fabric or flexible composite material 100 generally includes a substrate 102. One or more outer layers 104 may be provided on and/or at least partially cover an outer surface of the substrate 102. Additionally, or alternatively, one or more inner layers 106 may be provided on and/or at least partially cover an inner surface of the substrate 102. Non-limiting examples of outer layers 104 and/or inner layers 106 are discussed in detail below and may include, but are not limited to, films, coatings, adhesives, metallic layers, protective coatings, or a gas barrier layers. The layers 104, 106 are for illustrative purposes, and in other embodiments, other layers or materials may be utilized as the outer layer 104 and/or the inner layer 106. Moreover, the number of layers adhered to or covering the substrate 102 should not be considered limiting, and in some embodiments a plurality of layers or coverings may be provided on the outer surface and/or inner surface of the substrate 102.

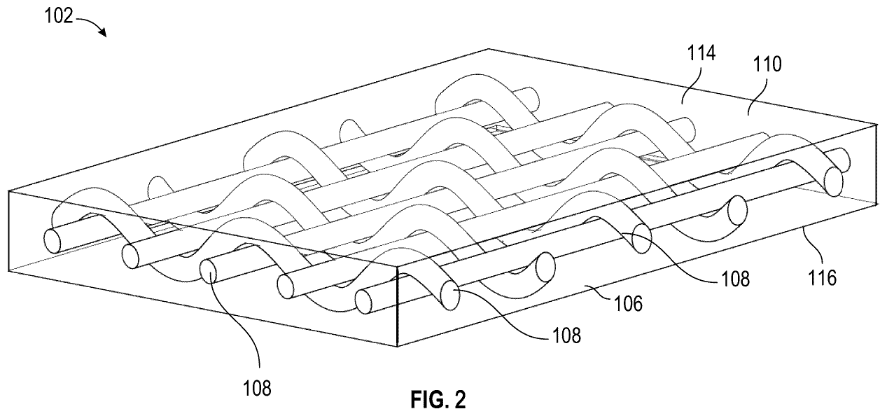

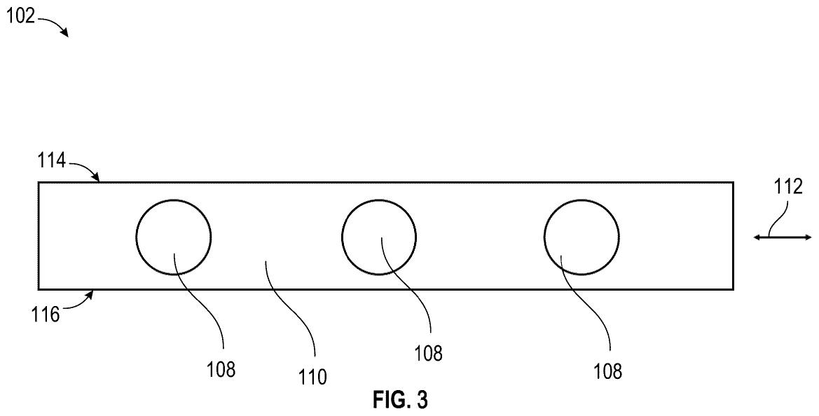

As best illustrated in FIGS. 2 and 3, the substrate 102 generally includes a plurality of fibers, filaments, threads, yarns, or tows 108 and a filling and/or sealing material 110.

The fibers, filaments, threads, yarns, or tows 108 may be various materials as desired, such as but not limited to polyethylene, ultra-high molecular weight polyethylene, polypropylene, polyester, polyamide, aromatic polyamide, aramid, polyolefin, aromatic polyester, polyarylate, other liquid crystal polymers, or nylon, and/or any combination thereof. In some non-limiting examples, the fibers, filaments, threads, yarns, or tows 108 may be a material such as but not limited to those sold under the trade names Dyneema®, Spectra®, Innegra®, Vectran®, Technora®, Kevlar®, Nylon-6, Nylon 6-6. In a further non-limiting example, the fibers, filaments, threads, yarns, or tows 108 may include long chains of polyethylene aligned in a same direction.

In certain embodiments, substrate 102 may have a weight of less than or approximately 4.5 ounces/yd², such as less than or approximately 3.5 ounces/yd², such as less than or approximately 3.0 ounces/yd², such as less than or approximately 2.5 ounces/yd², such as less than or approximately 2.0 ounces/yd², such as less than or approximately 1.5 ounces/yd², such as less than or approximately 1.0 ounce/yd², such as less than or approximately 0.5 ounces/yd².

According to certain embodiments of the present invention, the substrate may be a woven substrate or a nonwoven substrate.

Compared to traditional fabrics or flexible composite materials, the fabric or flexible composite material 100 with the substrate 102 may have fibers, filaments, threads, yarns, or tows 108 with a reduced thickness. A reduced thickness may be achieved by utilizing high strength to weight fibers, filaments, threads, yarns, or tows 108 such as but not limited to those sold under the trade names Dyneema®, Spectra®, Innegra®, Vectran® Technora®, or Kevlar®. The reduced thickness high strength to weight fibers, filaments, threads, yarns, or tows 108 may be various materials as desired, such as but not limited to polyethylene, ultra-high molecular weight polyethylene, polypropylene, polyester, polyamide, aromatic polyamide, aramid, polyolefin, aromatic polyester, polyarylate, other liquid crystal polymers, or nylon, and/or any combination thereof. The substrate of the fabric or flexible composite material may be a woven substrate or a nonwoven substrate.

In certain embodiments, low weight, high strength substrate 102 may include fibers, filaments, threads, yarns, or tows 103 with a tenacity greater than 8.8 grams/denier, such as a tenacity of greater or equal to 15 grams/denier, such as a tenacity of greater or equal to 20 grams/denier, such as a tenacity of greater or equal to 25 grams/denier, such as a tenacity of greater or equal to 30 grams/denier, such as a tenacity of greater or equal to 35 grams/denier, such as a tenacity of greater or equal to 40 grams/denier, such as a tenacity of greater or equal to 48 grams/denier. In some non-limiting examples, the tenacity may be from about 25 grams/denier to about 45 grams/denier, such as about 30 grams/denier to about 40 grams/denier.

Traditionally substrates with a strength to weight ratio or specific strength, herein referred to as tenacity, has a value typically expressed in grams of strength per mass in grams of 9000 meters, herein referred to as denier, which is a measure of linear density, of fibers, filaments, threads, yarns or tows used to manufacture panels, gas-holding fabrics, seam tapes, floor, sliding surface, girt, patch, handle, pouch, container, structural attachment, accessory, component, or other materials or components.

Optionally, in certain embodiments, the fabric or flexible composite material described herein, comprises a substrate comprising, fibers, filaments, threads, yarns or tows, with a tenacity of at least 8.8 g/den.

Utilizing fibers, filaments, threads, yarns, or tows 108 that have a reduced thickness and high strength to weight ratio may provide a substrate 102 with smaller gaps and voids between the fibers, filaments, threads, yarns, or tows 108. The fibers, filaments, threads, yarns, or tows 108 with reduced thickness and high strength to weight ratio may also provide less space and volume between an outer coating, film, or layer 104 and an inner coating, film, or layer 106.

Utilizing fibers, filaments, threads, yarns, or tows 108 with a reduced thickness make it possible to fill and/or seal the gaps and voids in the substrate 102 and within the fibers, filaments, threads, yarns, or tows 108 without significantly increasing the weight of the fabric or flexible composite material 100.

Using a non-woven substrate may reduce the space between the inner and outer coating and or films providing less space to fill and or seal.

The filling and/or sealing material 110 of the substrate 102 fills and/or seals gaps and voids that are defined between and/or within such fibers, filaments, threads, yarns, or tows 108, thereby restricting air or gas from travelling through the substrate 102. Referring to FIG. 3, the substrate 102 may define a substrate plane (represented by arrows 112), and the filling and/or sealing material 110 may restrict air or gas from travelling through the substrate 102 along the substrate plane 112 and/or at a non-zero angle (e.g., perpendicular) relative to the substrate plane 112. The filling and/or sealing material 110 may be various suitable materials for filling and/or sealing the gaps and voids and restricting air or gas from travelling through the substrate 102. As non-limiting examples, the filling and/or sealing material 110 may be sealant, resin, adhesive, glue, polymer, elastomer, rubber, or any other material as desired. In one non-limiting example, the filling and/or sealing material 110 is a thermoset material or a thermoplastic material. In non-limiting examples, the filling and/or sealing material 110 may be various adhesive or hot melt adhesive materials as desired, such as but not limited to copolymer, polyolefin, polyamide, nylon, low density polyethylene, high density polyethylene, ethylene vinyl acetate, polyester, polyurethane, ester-based polyurethane, ether-based polyurethane, urethane prepolymer, or reactive polyurethane.

The substrate 102 with the filling and/or sealing material 110 fills and/or seals the gaps and voids defined by and/or within the fibers, filaments, threads, yarns, or tows 108 may be considered a monolithic substrate 102. Unlike traditional fabrics or flexible composite materials, absent a puncture, cut, breech, abrasion, or other damage that extends completely through the substrate 102 and any films or coatings covering the substrate (e.g., from an outer surface 114 to an inner surface 116), the fabric or flexible composite material 100 may maintain gas-holding properties and restrict the travel of air or gas through the substrate 102. As such, compared to traditional fabrics or flexible composite materials, the fabric or flexible composite material with the substrate 102 has improved gas-holding properties and durability.

Referring back to FIG. 1, as mentioned, one or more outer layers 104 and/or one or more inner layers 106 may be provided with the substrate 102 to form the fabric or flexible composite material 100. The outer layer 104 and/or inner layer 106 may be various layers of material as desired, such as but not limited to a film layer, a coating layer, an adhesive layer, a metallic layer, a protective coating, or a gas barrier layer.

In one non-limiting example, the outer layer 104 and/or the inner layer 106 may be a metallic layer that at least partially covers the outer surface 114. When included, the metallic layer may be completely covering the outer surface 114. Additionally, or alternatively, at least a portion of the outer surface 114 is not covered by the metallic layer. Additionally, or alternatively, the metallic layer may be discontinuously covering the substrate 102 and may be provided at discrete locations covering the substrate 102. When the metallic layer is included, an intermediate adhesive layer and/or film layer optionally may be provided between the substrate 102 and the metallic layer.

The metallic layer may include various metals or metallic elements as desired, including but not limited to aluminum, aluminum alloys, titanium, titanium alloys, nickel, nickel alloys brass, brass alloys, steel, steel alloys, stainless steel, stainless steel alloy, silver, silver alloy, combinations thereof, and/or any other suitable metal or metallic elements as desired. The metallic layer optionally may be a continuous layer of the fabric or flexible composite material 100, meaning that the portions of the metallic layer are interconnected even though an entirety of the at least one surface of the substrate 102 is not necessarily covered.

The metallic layer may be deposited, adhered, and/or otherwise positioned to cover the substrate 102 (or intermediate adhesive layer and/or film layer) using various techniques as desired. As a non-limiting example, the metallic layer may be printed on, adhered to, vapor-deposited, or the like. In some embodiments, the metallic layer is plated, sputtered, or the like. In various embodiments, the metallic layer is a metallic foil layer is adhered to the substrate 102 or intermediate adhesive layer and/or film layer.

In certain embodiments, the fabric or flexible composite material 100 has an improved emissivity compared to traditional materials. In various aspects, the metallic layer reduces the emissivity of the fabric or flexible composite material 100 to less than or equal to 0.48, such as less than or equal to 0.25. In certain non-limiting examples, for materials having a melting temperature greater than polyethylene, the metallic layer may be used to reduce the emissivity of the fabric or flexible composite material 100 to less than or equal to 0.48 (although lower emissivity values could be used), and for materials with melting temperatures similar to and/or less than polyethylene, the metallic layer may be used to reduce the emissivity of the fabric or flexible composite material 100 to less than or equal to 0.25. An emissivity of 0 would mean that the fabric or flexible composite material reflects all heat, and a temperature of the fabric or flexible composite material would not significantly change when exposed to radiant heat. Conversely, an emissivity of 1 would mean that the fabric or flexible composite material is a perfect absorber, and all the heat would be absorbed. The reduced emissivity in turn limits the temperature that the substrate 102 (and other layers) is heated to when the fabric or flexible composite material 100 is exposed to radiant heat. As a non-limiting example, the substrate 102 may be an ultra-high molecular weight polyethylene substrate, and the metallic layer may limit the temperature the ultra-high molecular weight polyethylene substrate to about 199° F., or about 98° F. less than the melting temperature of the ultra-high molecular weight polyethylene substrate.

As another non-limiting example, the outer layer 104 and/or the inner layer 106 may be a coating or protective layer for protecting an intermediate layer (e.g., an intermediate metallic layer) and/or the substrate 102. In one non-limiting example, the protective layer may be an acrylic coating, although in other embodiments other suitable materials may be utilized as desired. Optionally, and when included, the protective layer may include a thin film layer, coating or other suitable layer that may minimize and/or prevent damage, oxidation, and/or corrosion of the metallic layer. In some embodiments, the exterior layer optionally includes a passivation layer, a parkerized layer, or other suitable layer that may be formed via a controlled oxidation process. In another embodiment, the exterior layer may minimize or prevent deterioration of the fabric or flexible composite material due to hydrolysis. In another embodiment, the exterior layer may provide or improve a bonding surface of the fabric or flexible composite material.

As yet another non-limiting example, the outer layer 104 and/or the inner layer 106 may be a gas barrier layer or film providing an air-tight or gas-tight seal. The gas barrier layer may be constructed from various materials. As non-limiting examples, the gas barrier layer may include a plastic-based layer, a urethane-based layer, a metallic layer, or any other suitable layer for allowing an inflatable safety product utilizing the fabric or flexible composite material 100 to be inflated with air or other gases. In certain embodiments, the filling and/or sealing material 110 fills and/or seals the gaps and voids of the substrate 102 and may restrict air or gas from travelling through the substrate 102 along a same plane as the gas barrier layer and/or at an angle (e.g., perpendicular) relative to a plane of the gas barrier layer. In various embodiments, the fabric or flexible composite material 100 with the substrate 102 may maintain air-holding or gas-holding properties when the gas barrier layer is punctured, cut, breeched, abraded, or otherwise damaged. As a non-limiting example, when traditional fabrics have an inside gas barrier breeched, air is able to travel along the plane of the substrate until it finds a hole or breech in the outside film or coating in the fabric where it can exit, thus rendering the fabric unable to act as a gas barrier anymore. With the fabric or flexible composite material described herein, by not allowing the air to travel through the substrate, if the inside gas barrier is damaged or if the internal gas is in contact with the substrate it cannot travel through the substrate and in-turn cannot find a pathway to the exterior of the air-holding or gas-holding fabric or flexible composite.

### FAA Requirements

In various embodiments, the fabric or flexible composite material described herein may meet and/or exceeds the fabric or flexible composite material requirements according to TSO-C69c from the Federal Aviation Administration (FAA), entitled EMERGENCY EVACUATION SLIDES, RAMPS, RAMP/SLIDES, AND SLIDE RAFTS and published Aug. 18, 1999 (“TSO-C69c”) (incorporated herein by reference), TSO-C13f from the FAA, entitled LIFE PRESERVERS and published Sep. 24, 1992 (“TSO-C13f”) (incorporated herein by reference), and/or TSO-C70b from the FAA, entitled LIFE RAFTS and published Aug. 4, 2014 (“TSO-C70b”) (incorporated herein by reference).

Required tests include: seam peel strength, seam shear strength, tensile strength (grab test), tear strength (trapezoid test), tear strength (tongue test), ply adhesion, coat adhesion, temperature resistance, radiant heat resistance, puncture strength, tear propagation, chafe resistance, flammability (vertical burn rate), pressure retention, permeability, porosity (hydrolysis), hydrolysis conditioning, resistance to hydrolysis, fluids exposure, and accelerated aging.

### Seam Adhesion

### TSO-C69c Requirement

As a non-limiting example, the fabric or flexible composite material adhered or welded to the fabric or flexible composite material of the inflatable safety product creating a seam region, when separated from the fabric or flexible composite material of the inflatable safety product, at or about a 180° angle, at a separation rate of between 2 and 2.5 inches/minute, at a temperature between 70° F. to 72° F., wherein the average of at least 5 specimens must resist separation with a force of 5 pounds/inch width or greater. The aforementioned resistance to separation, described herein peel strength as referenced in TSOs, such as but not limited to TSO-C69c from the FAA.

As a further non-limiting example, any coatings, films, or layers applied to the substrate of the fabric or flexible composite material, when separated from the substrate or other layers used in the construction of the fabric or flexible composite material, of the inflatable safety product, at or about a 180° angle, at a separation rate of between 2 and 2.5 inches/minute, at a temperature of between 70° F. to 72° F., wherein the average of at least 5 specimens must resist separation with a force of 5 pounds/inch width or greater. The aforementioned resistance to separation, described herein ply adhesion and coating adhesion as referenced in TSOs, such as but not limited to TSO-C69c from the FAA.

### Seam Shear

TSO-C69c Requirement

As a non-limiting example, the fabric or flexible composite material adhered or welded to the fabric or flexible composite material of the inflatable safety product creating a seam region, when used to create a specimen of the seam region and with the fabric or flexible composite material adhered or welded with a ¾ inch maximum overlap, at a separation rate between 11.5 and 12.5 inches/minute, at a temperature of 75° F., wherein the average of at least 3 specimens must resist separation with a force of 175 pounds/inch width or greater when pulled in the shear direction.

As a further non-limiting example, the fabric or flexible composite material adhered or welded to the fabric or flexible composite material of the inflatable safety product creating a seam region, when used to create a specimen of seam region 2 inches in length and with the fabric or flexible composite material adhered or welded at a ¾ inch maximum overlap, at a separation rate of between 11.5 and 12.5 inches/minute, at a temperature of 140° F., wherein the average of at least 3 specimens must resist separation with a force of 40 pounds/inch width or greater when the pulled in the shear direction. The aforementioned resistance to separation, describes shear strength as referenced in TSOs, such as but not limited to TSO-C69c from the FAA.

### Tensile and Tear Strength

### TSO-C69c Requirement

As a non-limiting example, the fabric or flexible composite material of the inflatable safety product, when at least 5 specimens prepared as per Federal Test Method Standard—Method 5134 (Tongue Test), are placed between 2 jaws that are 3 inches apart and subjected to a separation rate of between 11.5 and 12.5 inches/minute, at a temperature of 68° F. to 72° F., must a resist separation with a maximum force of an average of at least 13 pounds/inch in warp direction and fill direction (along the manufacturing length and width of the fabric or flexible composite material).

As a non-limiting example, the fabric or flexible composite material of the inflatable safety product, when at least 5 specimens prepared as per Federal Test Method Standard—Method 5136 (Trapezoid Test), are placed between 2 jaws that are 1 inch apart and subjected to a separation rate of between 11.5 and 12.5 inches/minute, at a temperature of 68° F. to 72° F., must a resist separation with a maximum force of an average of at least 13 pounds/inch in warp direction and fill direction (along the manufacturing length and width of the fabric or flexible composite material).

As a further non-limiting example, after aging (exposed to a temperature of 158±4° F. for not less than 168 hours), the fabric or flexible composite of the inflatable safety product, when at least 5 specimens prepared as per Federal Test Method Standard—Method 5134 (Tongue Test), are placed between 2 jaws that are 3 inches apart and subjected to a separation rate of between 11.5 and 12.5 inches/minute, at a temperature of 68° F. to 72° F., must a resist separation with a maximum force of an average of at least 13 pounds/inch in warp direction and fill direction (along the manufacturing length and width of the fabric or flexible composite material).

As a further non-limiting example, after aging, the fabric or flexible composite material of the inflatable safety product, when at least 5 specimens prepared as per Federal Test Method Standard—Method 5136 (Trapezoid Test), are placed between 2 jaws that are 1 inch apart and subjected to a separation rate between 11.5 and 12.5 inches/minute, at a temperature of 68° F. to 72° F., must a resist separation with a maximum force of an average of at least 13 pounds/inch in warp direction and fill direction (along the manufacturing length and width of the fabric or flexible composite material).

As a non-limiting example, the fabric or flexible composite material of the inflatable safety product, when at least 5 specimens prepared as per Federal Test Method Standard—Method 5100 (Grab Test), are placed between 2 jaws that are 3 inches apart and subjected to a separation rate between 11.5 and 12.5 inches/minute, at a temperature of 68° F. to 72° F., must resist separation with a maximum force of an average of at least 190 pounds/inch in warp direction and fill direction (along the manufacturing length and width of the fabric or flexible composite material).

As a further non-limiting example, after aging, the fabric or flexible composite material of the inflatable safety product, when at least 5 specimens prepared as per Federal Test Method Standard—Method 5100 (Grab Test), are placed between 2 jaws that are 3 inches apart and subjected to a separation rate between 11.5 and 12.5 inches/minute, at a temperature of 68° F. to 72° F., must a resist separation with a maximum force of an average of at least 190 pounds/inch in warp direction and fill direction (along the manufacturing length and width of the fabric or flexible composite material).

### Air Holding & Gas Holding

### TSO-C69c Requirement

As a non-limiting example, the fabric or flexible composite material, described herein when configured into an inflatable safety product must withstand a pressure of at least 1.5 times the maximum operating pressure for at least 5 minutes of its intended use.

As a further non-limiting example, the fabric or flexible composite material, described herein when configured into an inflatable safety product must withstand a pressure of at least 2 times the maximum operating pressure for at least 1 minute, of its intended use.

As a further non-limiting example, the fabric or flexible composite material, described herein when configured into an inflatable safety inflatable safety product, when inflated to its operating pressure of intended use must not fall below at least 50 percent of its initial pressure in a period less than 12 hours.

As a further non-limiting example, the fabric or flexible composite material, described herein when configured into an inflatable safety product, that is capable of being used as a life raft or flotation device when inflated to its operating pressure of intended use must not fall below the minimum raft mode operating pressure in less than 24 hours.

### Helium Permeability

### TSO-C69c Requirement

As a non-limiting example, the fabric or flexible composite material of the inflatable safety product, when at least 3 specimens are prepared and tested as per Federal Test Method Standard—Method 5460 or ASTM Method D1434-82, Procedure V, have a maximum permeability of Helium of 10 liters per square meter in 24 hours at 77° F. or its equivalent in Hydrogen when a pressure is applied to the chamber on the side of the test specimen that separates the test gas (Helium or its equivalent in Hydrogen) from the chamber receiving the permeating gas.

### Temperature Resistance

### TSO-C69c Requirement:

As a non-limiting example, the fabric or flexible composite material, seam tape, accessory material and or product accessories described herein when exposed to temperatures from −40° F. to 160° F. must remain fully functioning per its intended use as referenced in TSOs, such as but not limited to TSO-C69c from the FAA.

As a further non-limiting example, the fabric or flexible composite material, seam tape, accessory material and or product accessories described herein must remain fully functioning per its intended use after exposure to a storage temperature of 185° F. or greater as referenced in TSOs, such as but not limited to TSO-C69c from the FAA.

As a further non-limiting example, the fabric or flexible composite material, seam tape, accessory material and or product accessories described herein must remain fully functioning per its intended use after being stowed at a temperature −65° F. or less as referenced in TSOs, such as but not limited to TSO-C69c from the FAA.

### Radiant Heat Resistance

### TSO-C69c Requirement

As a further non-limiting example, the fabric or flexible composite material described herein when exposed to a radiant heat flux of 1.5 Btu/ft²-sec or greater, wherein a pressure applied to the surface opposite the heat source does not decrease for at least 90 seconds when the surface opposite the heat source is subjected to a higher pressure than the surface subjected to the heat source, wherein the average of the time to pressure decrease of at least 3 specimens of the fabric or flexible composite is at least 180 seconds or greater.

### Fluids Exposure

### TSO-C70b Requirement

As a further non-limiting example, the fabric or flexible composite material described herein must be capable of withstanding the detrimental effects of exposure to fuels, oils, hydraulic fluids, and sea water. After being exposed to fuels, oils, hydraulic fluids, and sea water, a seam will not have a decrease in seam strength or coat adhesion of more than 10%.

As a further non-limiting example, the fabric or flexible composite material, described herein must remain capable of withstanding the detrimental effects of exposure to fuels, oils, hydraulic fluids, and sea water with no loss in air holding or gas holding properties. After being exposed to fuels, oils, hydraulic fluids, and sea water, the fabric or flexible composite material, wherein the average of at least 5 specimens in warp direction and fill direction (along the manufacturing length and width of the fabric or flexible composite material) will not have a decrease in coating adhesion, ply adhesion, peel strength, seam shear strength, tensile strength, or tear strength of more than 10% as referenced in TSOs, such as but not limited to TSO-C70b from the FAA.

### Hydrolysis

### TSO-C69c Requirement

As a further non-limiting example, the fabric or flexible composite material, described herein must remain capable of withstanding the detrimental effects of hydrolysis exposure to a temperature of 136±4° F. at a relative humidity of 95±4 percent for a period of 50 days with no loss in air holding or gas holding properties. After hydrolysis exposure to a temperature of 136±4° F. at a relative humidity of 95±4 percent for a period of 50 days the fabric or flexible composite material, wherein the average of at least 5 specimens in warp direction and fill direction (along the manufacturing length and width of the fabric or flexible composite material) will not have a decrease in coating adhesion, ply adhesion, peel strength, seam shear strength, tensile strength, or tear strength of more than 20% as referenced in TSOs, such as but not limited to TSO-C69c from the FAA.

### Tear Propagation

### TSO-C69c Requirement

As a non-limiting example, the fabric or flexible composite material, described herein when must not allow a tear to propagate beyond the implement that caused an initial puncture or tear as referenced in TSOs, such as but not limited to TSO-C69c from the FAA.

### Accelerated Aging

### TSO-C69c Requirement

As a further non-limiting example, the fabric or flexible composite material, described herein must remain capable of withstanding the detrimental effects of accelerated aging at a temperature of 158±4° F. for not less than 168 hours with no loss in air holding or gas holding properties. After accelerated aging at a temperature of 158±4° F. for not less than 168 hours the fabric or flexible composite material, seam tape, accessory material wherein the average of at least 5 specimens in warp direction and fill direction (along the manufacturing length and width of the fabric or flexible composite material) will not have a decrease in coating adhesion, ply adhesion, peel strength, seam shear strength, tensile strength, or tear strength of more than 10% as referenced in TSOs, such as but not limited to TSO-C69c from the FAA.

### Flammability

### TSO-C69c Requirement

As a non-limiting example, the fabric or flexible composite material, described herein, wherein the average of at least 3 specimens in warp direction and fill direction (along the manufacturing length and width of the fabric or flexible composite material material) are located ¾ inches above the top edge of a burner apparatus, for a period of 12 seconds is exposed to a flame with a total length of 1.5 inches and an inner cone length of ⅞ inches, and minimum temperature of 1550° F., shall not burn for more than 15 seconds after the flame is removed, shall not burn more than 8 inches in the vertical direction, wherein any material that drips form the specimen shall not burn to more than 5 seconds, as referenced such as but not limited to the flammability requirements of 14 CFR part 25.853(a), Appendix F, Part I (a)(1)(ii) as referenced in TSOs, such as but not limited to TSO-C69c from the FAA.

### Examples

A collection of exemplary embodiments is provided below, including at least some explicitly enumerated as “Examples” providing additional description of a variety of example embodiments in accordance with the concepts described herein. These illustrations are not meant to be mutually exclusive, exhaustive, or restrictive; and the disclosure not limited to these example illustrations but rather encompasses all possible modifications and variations within the scope of the issued claims and their equivalents.

Example 1. A fabric or flexible composite material for an inflatable safety product, the fabric or flexible composite material comprising: a substrate comprising a plurality of gaps and voids; and a material filling and/or sealing the gaps and voids of the substrate.

Example 2. The fabric or flexible composite material of any of the preceding or subsequent examples or combination of examples, wherein a film covers a surface of the substrate.

Example 3. The fabric or flexible composite material of any of the preceding or subsequent examples or combination of examples, wherein the substrate comprises polyethylene.

Example 4. The fabric or flexible composite material of any of the preceding or subsequent examples or combination of examples, wherein the substrate comprises ultra-high molecular weight polyethylene.

Example 5. The fabric or flexible composite material of any of the preceding or subsequent examples or combination of examples, wherein the substrate comprises polyethylene, ultra-high molecular weight polyethylene, polypropylene, polyester, polyamide, aromatic polyamide, aramid, polyolefin, aromatic polyester, polyarylate, other liquid crystal polymers, or nylon.

Example 6. The fabric or flexible composite material of any of the preceding or subsequent examples or combination of examples, wherein the fabric or flexible composite material comprises a tensile strength of at least 190 lbs/in and a tear strength of at least 13 lbs/in.

Example 7. The fabric or flexible composite material of any of the preceding or subsequent examples or combination of examples, wherein the fabric or flexible composite material comprises a fabric or flexible composite material weight less than 8 ounces/yd²

Example 8. The fabric or flexible composite material of any of the preceding or subsequent examples or combination of examples, wherein the fabric or flexible composite material comprises an emissivity value of 0.48 or less.

Example 9. The fabric or flexible composite material of any of the preceding or subsequent examples or combination of examples, wherein the substrate defines a surface, and wherein the fabric or flexible composite material further comprises a metallic layer at least partially covering the surface.

Example 10. The fabric or flexible composite material of any of the preceding or subsequent examples or combination of examples, wherein the metallic layer completely covers the surface.

Example 11. The fabric or flexible composite material of any of the preceding or subsequent examples or combination of examples, wherein the metallic layer comprises aluminum, an aluminum alloy, titanium, a titanium alloy, nickel, a nickel alloy, brass, a brass alloy, steel, a steel alloys, stainless steel or a stainless steel alloy, silver, a silver alloy, combinations thereof, or any other suitable metal or metallic alloy.

Example 12. The fabric or flexible composite material of any of the preceding or subsequent examples or combination of examples, wherein the fabric or flexible composite material comprises a radiant heat resistance of at least 180 seconds.

Example 13. The fabric or flexible composite material of any of the preceding or subsequent examples or combination of examples, wherein the substrate defines a substrate plane, and wherein the material filling and/or sealing the gaps and voids of the substrate restricts air or gas from travelling through the substrate along the substrate plane.

Example 14. The fabric or flexible composite material of any of the preceding or subsequent examples or combination of examples, wherein a film covers at least one surface of the substrate and the material filling and/or sealing the gaps and voids of the substrate restricts air or gas from traveling through the substrate along a same plane as the film.

Example 15. The fabric or flexible composite material of any of the preceding or subsequent examples or combination of examples, wherein a film covers a surface of the substrate and the material filling and/or sealing the gaps and voids of the substrate restricts air or gas from traveling through the substrate perpendicular to the plane of the film.

Example 16. The fabric or flexible composite material of any of the preceding or subsequent examples or combination of examples, wherein the substrate defines a substrate plane, and wherein the material filling and/or sealing the gaps and voids of the substrate restricts air or gas from travelling through the substrate perpendicular to the substrate plane.

Example 17. The fabric or flexible composite material of any of the preceding or subsequent examples or combination of examples, wherein the fabric or flexible composite material maintains air-holding and/or gas-holding properties when a film covering the substrate is punctured, cut, breeched, abraded, or damaged.

Example 18. The fabric or flexible composite material of any of the preceding or subsequent examples or combination of examples, wherein the fabric or flexible composite material is a panel, gas-holding fabric or flexible composite material, a seam tape fabric or flexible composite material, a floor fabric or flexible composite material, a sliding surface fabric or flexible composite material, a girt fabric or flexible composite material, a patch fabric or flexible composite material, a handle fabric or flexible composite material, a pouch fabric or flexible composite material, a container fabric or flexible composite material, a structural attachment fabric or flexible composite material, an accessory fabric or flexible composite material, a component fabric or flexible composite material.

Example 19. An inflatable safety product comprising the fabric or flexible composite material of any of the preceding or subsequent examples or combination of examples as a panel, gas-holding fabric, seam tape, floor, sliding surface, girt, patch, handle, pouch, container, structural attachment, accessory, or component.

Example 20. The inflatable safety product of any of the preceding or subsequent examples or combination of examples, wherein the inflatable safety product comprises an inflatable evacuation slide, inflatable evacuation slide/raft, inflatable evacuation ramp, inflatable evacuation slide/ramp, life raft, life vest, or helicopter float.

Example 21. The fabric or flexible composite material of any of the preceding or subsequent examples or combination of examples, wherein the substrate contains fibers, filaments, threads, yarns, or tows.

Example 22. The fabric or flexible composite material of any of the preceding or subsequent examples or combination of examples, wherein the material filling and/or sealing the gaps and voids of the substrate reduces the substrate's helium permeability to 10 liters per square meter in 24 hours at 77° F. or less.

Example 26. The fabric or flexible composite material of any of the preceding or subsequent examples or combination of examples, wherein the material filling and/or sealing the gaps and voids of the substrate restricts air or gas from traveling through the substrate.

Example 27. The fabric or flexible composite material of any of the preceding or subsequent examples or combination of examples, wherein the material filling and/or sealing the gaps and voids of the substrate is sealant, resin, adhesive, glue, polymer, elastomer, rubber, or any other material that restricts air or gas from traveling through the substrate.

Example 28. The fabric or flexible composite material of any of the preceding or subsequent examples or combination of examples, wherein the material filling and/or sealing the gaps and voids of the substrate is a thermoset or thermoplastic material.

Example 29. A fabric or flexible composite material for an inflatable safety product, the fabric or flexible composite material comprising: a substrate defining a substrate plane; and a material filling and/or sealing the gaps and voids of the substrate, wherein the material filling and/or sealing the gaps and voids of the substrate prevents gas from travelling through the substrate along the substrate plane.

Example 30. The fabric or flexible composite material of any of the preceding or subsequent examples or combination of examples, wherein the substrate comprises polyethylene, ultra-high molecular weight polyethylene, polypropylene, polyester, polyamide, aromatic polyamide, aramid, polyolefin, aromatic polyester, polyarylate, other liquid crystal polymers, or nylon.

Example 31. A fabric or flexible composite material for an inflatable safety product, the fabric or flexible composite comprising a substrate and a film covering a surface of the substrate, wherein the fabric or flexible composite material maintains air-holding or gas-holding properties when a film covering the substrate is punctured, cut, breeched, abraded, or damaged.

Example 32. The fabric or flexible composite material of any of the preceding or subsequent examples or combination of examples, wherein the substrate comprises polyethylene, ultra-high molecular weight polyethylene, polypropylene, polyester, polyamide, aromatic polyamide, aramid, polyolefin, aromatic polyester, polyarylate, other liquid crystal polymers, or nylon.

Different arrangements of the components depicted in the drawings or described above, as well as components and steps not shown or described are possible. Similarly, some features and sub-combinations are useful and may be employed without reference to other features and sub-combinations. Embodiments of the invention have been described for illustrative and not restrictive purposes, and alternative embodiments will become apparent to readers of this patent. Accordingly, the present invention is not limited to the embodiments described above or depicted in the drawings, and various embodiments and modifications may be made without departing from the scope of the claims below.

The use of the terms “a” and “an” and “the” and similar referents in the context of describing the invention (especially in the context of the following claims) are to be construed to cover both the singular and the plural, unless otherwise indicated herein or clearly contradicted by context. Directional references such as “up,” “down,” “top,” “bottom,” “left,” “right,” “front,” and “back,” among others, are intended to refer to the orientation as illustrated and described in the figure (or figures) to which the components and directions are referencing. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, or gradients thereof, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the invention, and does not pose a limitation on the scope of the invention unless otherwise claimed. No language in the specification should be construed as indicating any non-claimed element as essential to the practice of the invention.

As used herein, the term “substantially” refers to the complete or nearly complete extent or degree of an action, characteristic, property, state, structure, item, or result. For example, an object that is “substantially” enclosed would mean that the object is either completely enclosed or nearly completely enclosed. The exact allowable degree of deviation from absolute completeness may in some cases depend on the specific context. However, the nearness of completion will be so as to have the same overall result as if absolute and total completion were obtained.

All ranges disclosed herein are to be understood to encompass any and all subranges subsumed therein. For example, a stated range of “1 to 10” should be considered to include any and all subranges between (and inclusive of) the minimum value of 1 and the maximum value of 10; that is, all subranges beginning with a minimum value of 1 or more, e.g. 1 to 6.1, and ending with a maximum value of 10 or less, e.g., 5.5 to 10.

Preferred embodiments of this invention are described herein, including the best mode known to the inventors for carrying out the invention. The invention is susceptible to various modifications and alternative constructions, and certain shown exemplary embodiments thereof are shown in the drawings and have been described above in detail. Variations of those preferred embodiments, within the spirit of the present invention, may become apparent to those of ordinary skill in the art upon reading the foregoing description. The inventors expect skilled artisans to employ such variations as appropriate, and the inventors intend for the invention to be practiced otherwise than as specifically described herein. Accordingly, it should be understood that there is no intention to limit the invention to the specific form or forms disclosed, but on the contrary, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of specific embodiments are presented for purposes of illustration and description. They are not intended to be exhaustive or to limit the described embodiments to the precise forms disclosed. It will be apparent to one of ordinary skill in the art that many modifications and variations are possible in view of the above teachings.

1. A fabric or flexible composite material for an inflatable safety product, the fabric or flexible composite material comprising:
a substrate comprising a plurality of internal gaps and voids; and
a filling material filling and sealing the internal gaps and voids of the substrate,
wherein the fabric or flexible composite material comprises a tensile strength of at least 190 lbs/in and a tear strength of at least 13 lbs/in.

2. The fabric or flexible composite material of claim 1, further comprising a film covering a surface of the substrate.

3. The fabric or flexible composite material of claim 1, wherein the substrate comprises polyethylene.

4. The fabric or flexible composite material of claim 3, wherein the substrate comprises ultra-high molecular weight polyethylene.

5. The fabric or flexible composite material of claim 1, wherein the substrate comprises at least one of polyethylene, ultra-high molecular weight polyethylene, polypropylene, polyester, polyamide, aromatic polyamide, aramid, polyolefin, aromatic polyester, or polyarylate.

6. (canceled)

7. The fabric or flexible composite material of claim 1, wherein the fabric or flexible composite material comprises a fabric or flexible composite material weight less than 8 ounces/yd²

8. The fabric or flexible composite material of claim 1, wherein the fabric or flexible composite material comprises an emissivity value of 0.48 or less.

9. The fabric or flexible composite material of claim 1, wherein the substrate defines a surface, and wherein the fabric or flexible composite material further comprises a metallic layer at least partially covering the surface.

10. The fabric or flexible composite material of claim 9, wherein the metallic layer completely covers the surface.

11. The fabric or flexible composite material of claim 9, wherein the metallic layer comprises at least one of aluminum, an aluminum alloy, titanium, a titanium alloy, nickel, a nickel alloy, brass, a brass alloy, steel, a steel alloys, stainless steel or a stainless steel alloy, silver, or a silver alloy.

12. The fabric or flexible composite material of claim 1, wherein the fabric or flexible composite material comprises a radiant heat resistance of at least 180 seconds.

13. The fabric or flexible composite material of claim 1, wherein the substrate defines a substrate plane, and wherein the filling material restricts gas from travelling through the substrate along the substrate plane.

14. (canceled)

15. (canceled)

16. The fabric or flexible composite material of claim 1, wherein the substrate defines a substrate plane, and wherein the filling material restricts gas from travelling through the substrate perpendicular to the substrate plane.

17. The fabric or flexible composite material of claim 1, wherein the fabric or flexible composite material maintains air-holding and/or gas-holding properties when a film covering a surface of the substrate is punctured.

18. The fabric or flexible composite material of claim 1, wherein the fabric or flexible composite material is a panel, gas-holding fabric or flexible composite material, a seam tape fabric or flexible composite material, a floor fabric or flexible composite material, a sliding surface fabric or flexible composite material, a girt fabric or flexible composite material, a patch fabric or flexible composite material, a handle fabric or flexible composite material, a pouch fabric or flexible composite material, a container fabric or flexible composite material, a structural attachment fabric or flexible composite material, an accessory fabric or flexible composite material, or a component fabric or flexible composite material.

19. An inflatable safety product comprising the fabric or flexible composite material of claim 1, wherein the fabric or flexible composite material is a panel, gas-holding fabric, seam tape, floor, sliding surface, girt, patch, handle, pouch, container, structural attachment, accessory, or component.

20. The inflatable safety product of claim 19, wherein the inflatable safety product comprises an inflatable evacuation slide, inflatable evacuation slide/raft, inflatable evacuation ramp, inflatable evacuation slide/ramp, life raft, life vest, or helicopter float.

21. (canceled)

22. The fabric or flexible composite material of claim 1, wherein the filling material reduces a helium permeability of the substrate to 10 liters per square meter in 24 hours at 77° F. or less.

23. (canceled)

24. The fabric or flexible composite material of claim 1, wherein the filling material is sealant, resin, adhesive, glue, polymer, elastomer, or rubber.

25. The fabric or flexible composite material of claim 1, wherein the filling material is a thermoset or thermoplastic material.

26. A fabric or flexible composite material for an inflatable safety product, the fabric or flexible composite material comprising:
a substrate comprising a first side and a second side, wherein a distance from the first side to the second side is a thickness of the substrate, and wherein the substrate defines a substrate plane extending in a direction perpendicular to the thickness, wherein the substrate comprises a plurality of filaments defining gaps and voids therebetween and
a filling material, the filling material filling and sealing the gaps and voids of the substrate defined by the plurality of filaments, wherein the filling material prevents gas from travelling through the substrate along the substrate plane.

27. The fabric or flexible composite material of claim 26, wherein the substrate comprises at least one of polyethylene, ultra-high molecular weight polyethylene, polypropylene, polyester, polyamide, aromatic polyamide, aramid, polyolefin, aromatic polyester, or polyarylate.

28. A fabric or flexible composite material for an inflatable safety product, the fabric or flexible composite comprising:
a substrate comprising a first side and a second side opposite the first, the substrate comprising a plurality of filaments defining a plurality of voids and gaps between the first side and the second side, wherein the substrate defines a substrate plane extending in a direction parallel to a direction from the first side to the second side of the substrate, wherein the substrate comprises a weight less than 4.5 ounces/yd² and a yarn tenacity of at least 8.8 grams/denier; and
a filling material filling and sealing the voids and gaps of the substrate,
wherein the filling material restricts gas from travelling through the substrate along the substrate plane.

29. The fabric or flexible composite material of claim 28, wherein the substrate comprises at least one of polyethylene, ultra-high molecular weight polyethylene, polypropylene, polyester, polyamide, aromatic polyamide, aramid, polyolefin, aromatic polyester, or polyarylate.

30. The fabric or flexible composite material of claim 28, further comprising a film covering at least one of the first side or the second side of the substrate, wherein the filling material restricts gas from travelling through the substrate along the substrate plane and such that the fabric or flexible composite material maintains air-holding or gas-holding properties when the film is punctured.

31. The fabric or flexible composite material of claim 1, wherein the filling material comprises at least one of polyolefin, polyamide, nylon, low density polyethylene, high density polyethylene, ethylene vinyl acetate, polyester, polyurethane, ester-based polyurethane, ether-based polyurethane, urethane prepolymer, or reactive polyurethane.

32. The fabric or flexible composite material of claim 1, wherein the substrate comprises a weight less than 4.5 ounces/yd² and a yarn tenacity of at least 8.8 grams/denier.
